(19) United States
(12) Patent Application Publication
(10) Pub. No.: US 2022/0011697 A1
(43) Pub. Date: Jan. 13, 2022

(54) IMAGE FORMING APPARATUS AND IMAGE FORMING METHOD

(71) Applicant: Konica Minolta, Inc., Tokyo (JP)

(72) Inventor: Kazuyoshi Kimura, Tokyo (JP)

(73) Assignee: Konica Minolta, Inc., Tokyo (JP)

(21) Appl. No.: 17/340,860

(22) Filed: Jun. 7, 2021

(30) Foreign Application Priority Data
Jul. 9, 2020 (JP) 2020-118514

(51) Int. Cl. G03G 15/20; G03G 15/16

(52) U.S. Cl. CPC G03G 15/20; G03G 15/1675

(57) ABSTRACT

An image forming apparatus includes: an image former that forms an image with toner containing wax on an image forming medium; a first paper loading part that loads the image forming medium and is located downstream of the image former; a laminator that laminates a film on the image forming medium; a second paper loading part that loads the image forming medium and is located downstream of the laminator; a first path that extends from the image former to the first paper loading part; a second path that extends from the image former to the laminator; a switcher that switches a conveyance path of the image forming medium to either the first path or the second path; and a hardware processor that causes the switcher to switch the conveyance path to the second path when the laminator laminates the film on the image forming medium.

### CROSS-REFERENCE TO RELATED APPLICATION

The entire disclosure of Japanese patent Application No. 2020-118514, filed on Jul. 9, 2020, is incorporated herein by reference.

### BACKGROUND

### Technical Field

The present invention relates to an image forming apparatus and an image forming method.

### Description of the Related Art

In recent years, lamination processing on printed matter formed with an image by an electrophotographic method has been increasing. In the lamination processing, a lamination film made of a resin such as polypropylene is attached to a surface of the printed matter. The lamination processing enhances gloss of the printed matter and protects the printed matter itself.

As a conventional image forming apparatus that performs lamination processing, for example, there are techniques disclosed in JP 2006-350069 A and JP S63-6585 A.

In an electrophotographic copying machine with a laminating function of JP 2006-350069 A, a mode can be switched for lamination processing by rotating a fixing part.

In addition, in an electrophotographic copying machine with a laminating function of JP S63-6585 A, only a carrying device and a fixing device can operate when laminating sheet-shaped printed matter or the like with a transparent synthetic resin film on which an adhesive layer is formed.

Meanwhile, there are two types of methods in lamination processing, depending on a processing temperature.

One is hot laminating. In hot laminating, a lamination film is layered on printed matter and pressed while being heated to about 100° C.

Another one is cold laminating. In cold laminating, a lamination film is layered on printed matter and pressed while being heated at a temperature from room temperature to about 40° C.

Whereas, toner used in an electrophotographic method contains wax. The wax melts from the toner by heat to be precipitated on a surface of paper. During a fixing operation, the wax that has melted from the toner and been precipitated cools and solidifies after fixing. The wax after solidification gives gloss to an image surface. However, the wax that has once solidified softens when the temperature exceeds about 60° C., and melts again from the toner to be precipitated on the surface of the paper when the temperature rises further.

This effect of heat on the wax has not been considered in any of conventional techniques for lamination processing on printed matter formed with an image by the electrophotographic method.

For this reason, when printed matter using the toner is subjected to lamination processing by hot laminating, the wax that has once solidified softens and an image becomes unclear, or an amount of precipitation on a paper surface increases to cause poor adhesiveness of the lamination film.

Whereas, in cold laminating, paper heated at the time of fixing may not be sufficiently cooled, and an adhesive of a film for cold laminating may be denatured by heat, resulting in poor adhesion. Note that, a pouch that covers paper from both sides with a resin film that is larger than the paper is different from the lamination processing.

### SUMMARY

Therefore, one or more embodiments of the present invention provide an image forming apparatus and an image forming method capable of obtaining printed matter subjected to lamination processing in a good state even in a case of printed matter using toner.

According to one or more embodiments of the present invention, an image forming apparatus comprises: an image forming part (i.e., image former) that forms, on an image forming medium, an image with toner containing wax; a first paper loading part that loads the image forming medium, and is located downstream of the image forming part in a conveyance direction of the image forming medium; a laminator that performs lamination processing on the image forming medium; a second paper loading part that loads the image forming medium, and is located downstream of the laminator in a conveyance direction of the image forming medium; a first path from the image forming part to the first paper loading part; a second path that is different from the first path and is from the image forming part to the laminator; a switcher that switches a conveyance path of the image forming medium outputted from the image forming part, to either the first path or the second path; and a hardware processor that switches the switcher to cause the image forming medium to be directed to the second path when lamination processing is to be performed on the image forming medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic view showing a configuration of an image forming apparatus according to one or more embodiments of the present invention;

FIG. 2 is a block diagram showing a control system of an image forming apparatus according to a first embodiment;

FIG. 3 is an enlarged side view of a paper stocker portion in the first embodiment;

FIG. 4 is a flowchart showing a processing procedure of an image forming method;

FIG. 5 is an enlarged side view of a paper stocker portion in a second embodiment;

FIG. 6 is a block diagram showing a control system of an image forming apparatus according to the second embodiment;

FIG. 7 is an enlarged side view of a paper stocker portion in a third embodiment; and

FIG. 8 is an enlarged side view of a paper stocker portion in a fourth embodiment.

### DETAILED DESCRIPTION OF EMBODIMENTS

Hereinafter, embodiments of the present invention will be described with reference to the drawings. However, the scope of the invention is not limited to the disclosed embodiments. In the description of the drawings, the same elements are denoted by the same reference numerals, and redundant descriptions are omitted. Further, the dimensional ratios in the drawings are exaggerated for convenience of description, and may differ from the actual ratios.

### First Embodiment

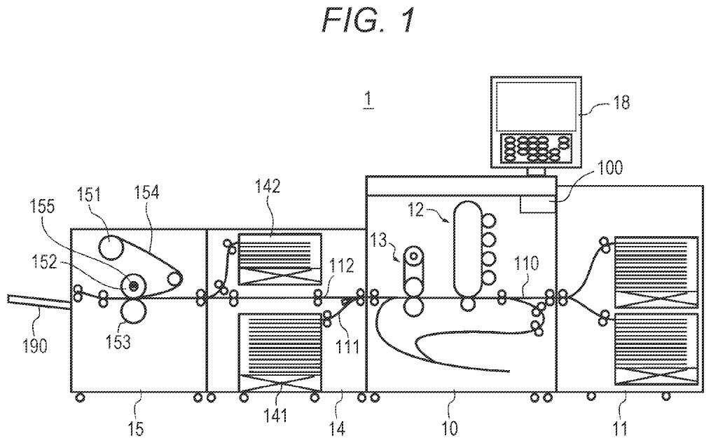

FIG. 1 is a schematic view showing a configuration of an image forming apparatus according to one or more embodiments of the present invention.

An image forming apparatus 1 includes an image forming part (i.e., image former) 10, a paper feeding part 11, a paper stocker 14, and a laminator 15.

The image forming part 10 forms (prints) an image on paper by a known electrophotographic method. The image forming part 10 has an image forming engine 12 and a fixing part 13. The image forming part 10 is controlled by a control part 100, which will be described later, to print in synchronization with a conveyance timing and a conveyance speed of paper. The paper printed with the image is outputted to the paper stocker 14.

The image forming engine 12 is a tandem type. The image forming engine 12 has a plurality of photoconductor drums and toner units (not illustrated) for individual colors, although details are omitted because they are known. The plurality of photoconductor drums and toner units correspond to the respective colors of yellow (Y), magenta (M), cyan (C), and black (K). Each color toner contains wax. The wax gives gloss on an image after printing.

The fixing part 13 fixes, to the paper, the toner image transferred to the paper, at a predetermined fixing temperature and pressure. The fixing part 13 is controlled by the control part 100.

The paper feeding part 11 stores paper, which is an image forming medium. The paper feeding part 11 supplies the paper to a conveyance path 110 that conveys the paper in the image forming apparatus 1. The conveyance path 110 has a plurality of rollers, and continues from the paper feeding part 11 to the image forming part 10 and the paper stocker 14. The paper stocker 14 will be described later.

The laminator 15 performs lamination processing on paper after printing. The laminator 15 is a cold laminator that performs lamination processing at a low temperature from room temperature to about 40° C.

The laminator 15 has a lamination film roller 151, an upper roller 152, and a lower roller 153.

The lamination film roller 151 is configured by winding a lamination film 154. The lamination film roller 151 sends out the lamination film 154 toward the upper roller 152. The lamination film 154 is a film for cold laminating. A heat-resistant temperature of a resin material used for the film for cold laminating varies is depending on a product, and is, for example, 100 to 150° C. The resin material used for the film for cold laminating is, for example, a polypropylene film, a polyester film, vinyl chloride, fluororesin, or the like.

Depending on a product, a heat-resistant temperature of an adhesive used for the film for cold laminating may be lower than that of the resin material of the film, and may be denatured at about 40 to 80° C. to cause poor adhesion. For this reason, cold laminators often use a temperature from room temperature to about 40° C.

The upper roller 152 has a halogen heater 155 inside, which is a heating source. However, when the lamination film 154 is used at room temperature, the halogen heater 155 is unnecessary. Further, turning on and off of the halogen heater 155 may be controlled by the control part 100 in accordance with the lamination film 154 to be used. For example, the control part 100 turns off the halogen heater 155 when the lamination film 154 that can be processed at room temperature is used, and turns on the halogen heater 155 when the lamination film 154 to be heat-processed is used.

The upper roller 152 is configured by, for example, coating a surface of an aluminum core metal with a fluorine material.

The lower roller 153 pressurizes in a direction of the upper roller 152. The lower roller 153 rotates in synchronization with a rotation of the upper roller 152. The lower roller 153 has, for example, a silicone rubber layer formed on a surface of an aluminum or stainless steel core metal, and a surface of the silicone rubber layer is coated with a fluorine material.

The upper roller 152 and the lower roller 153 form a nip for lamination. To the nip for lamination, paper layered with the lamination film 154 is conveyed. The paper and the lamination film 154 passing through the nip for lamination are welded by the heat of the halogen heater 155. The welded lamination film 154 is cut by a splitter (not illustrated) provided on a downstream side of the nip for lamination.

The paper subjected to lamination processing is discharged to a second paper loading part 190 provided on a downstream side of the laminator 15. The second paper loading part 190 is located on a downstream side of the laminator 15 in a paper conveyance direction. In the figure, the second paper loading part 190 shows a form of a paper discharging tray. However, the second paper loading part 190 may be in a box form or a cart form with casters, similarly to a case of a first paper loading part 141 (described later).

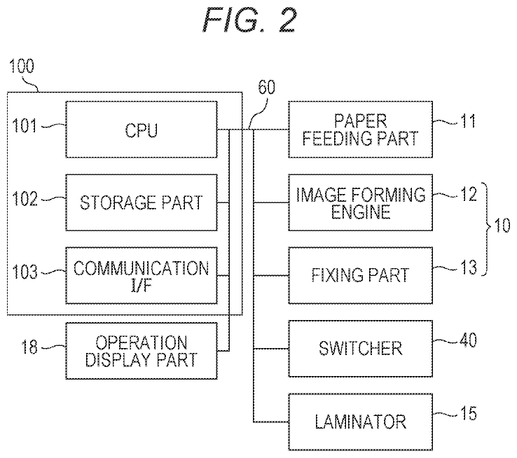

FIG. 2 is a block diagram showing a control system of the image forming apparatus 1 according to the first embodiment. The image forming apparatus 1 has the control part 100 in the image forming part 10. The control part 100 controls the paper feeding part 11, the image forming engine 12, the fixing part 13, a switcher 40 (described later), and the laminator 15. As shown in FIG. 2, the control part 100 and each part of the image forming apparatus 1 are connected by a signal line 60.

The control part 100 is a computer, and includes a CPU 101, a storage part 102, a communication interface (I/F) 103, and the like. Further, to the control part 100, an operation display part 18 is connected.

The CPU 101 executes control of each part and various arithmetic processes on the basis of various programs and various data.

The storage part 102 includes a ROM that stores various programs and various data in advance, a RAM that temporarily stores programs and data as a work area of the CPU101, a hard disk that stores various programs and various data, and the like.

The communication interface 103 connects the image forming apparatus 1 and an external device by data communication. The external device is, for example, a computer or a mobile terminal, and transmits print data to the image forming apparatus 1. As the communication interface 103, there is used, for example, a network interface based on standards such as SATA, PCI Express, USB, Ethernet (registered trademark), or IEEE1394, or a wireless communication interface such as Bluetooth (registered trademark) or IEEE 802.11.

The operation display part 18 includes a display with a touch panel, a numeric keypad, a start button, a stop button, and the like. The operation display part 18 displays a status of each part, image data, and the like. In addition, the operation display part 18 is used for inputting instructions from a user, such as various settings related to image formation.

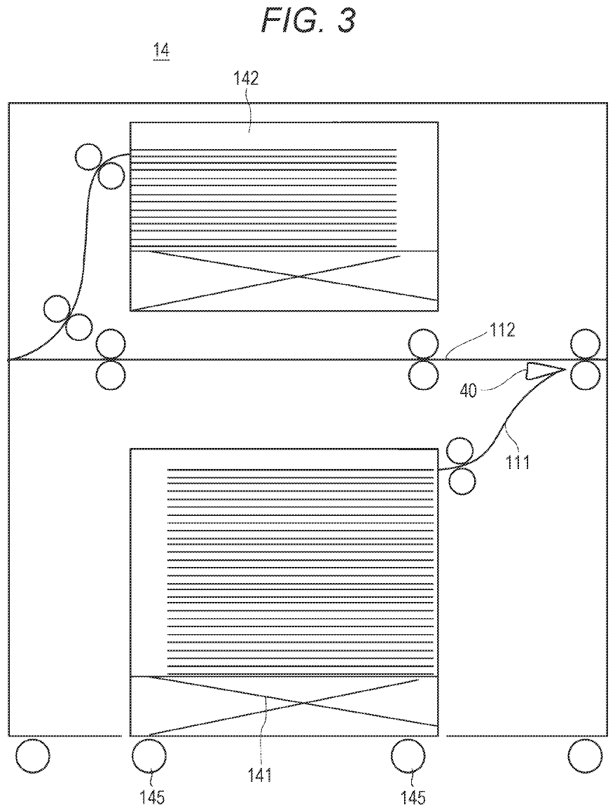

Next, the paper stocker 14 and an internal conveyance path will be described in detail. FIG. 3 is an enlarged side view of a paper stocker portion in the first embodiment.

To the paper stocker 14, paper outputted from the image forming part 10 is inputted. As shown in FIGS. 1 and 3, the paper stocker 14 has the first paper loading part 141 and an insertion paper loading part 142.

The first paper loading part 141 is located on a downstream side of the image forming part 10 in the paper conveyance direction, and loads the paper outputted from the image forming part 10 as it is. The first paper loading part 141 is in a box form or a cart form with casters 145. The first paper loading part 141 having such a form can load a large amount of paper because a surface on which the paper is loaded can be close to a floor surface, and is easy to handle and very convenient. The insertion paper loading part 142 feeds paper other than the image-formed paper to the laminator 15. The insertion paper loading part 142 may include an auto document feeder (ADF) (not illustrated), in addition to loading the paper to be inserted. On the contrary, the insertion paper loading part 142 need not be provided unless there is an application for directly inserting other paper into the laminator 15.

Inside the paper stocker 14, a first path 111 and a second path 112 having different conveyance destinations are provided in order to convey paper inputted from the image forming part 10.

The first path 111 conveys the paper to the first paper loading part 141. The second path 112 passes above the first paper loading part 141, and conveys the paper to the laminator 15. At a paper inlet portion of the paper stocker 14, the switcher 40 that switches the conveyance path to either the first path 111 or the second path 112 is provided. The switcher 40 is controlled by the control part 100.

When paper printed with an image is to be loaded as it is, the control part 100 switches the switcher 40 to a direction in which the paper is conveyed to the first path 111. Whereas, when lamination processing is to be performed on the paper printed with the image, the control part 100 switches the switcher 40 to a direction in which the paper is conveyed to the second path 112. The switcher 40 shown in FIG. 3 is in a state of being switched to the direction in which the paper is conveyed to the second path 112.

The second path 112 is longer than the first path 111. Therefore, the paper conveyed through the second path 112 is naturally cooled by the time when reaching the laminator 15.

The paper immediately after being outputted from the image forming part 10 enters the second path 112 at a temperature of 100 to 160° C. due to heating by the fixing part 13. The paper is cooled to a temperature equal to or lower than a predetermined temperature by being conveyed through the second path 112. The predetermined temperature is a temperature lower than a temperature at which solidified wax softens. The temperature at which the wax softens is about 60° C. Therefore, the predetermined temperature may be preferably about 55° C. with a margin in one or more embodiments.

Cold laminating is executed at a temperature from room temperature to about 40° C., depending on a film to be used. Therefore, the predetermined temperature may be an upper limit temperature used in cold laminating in one or more embodiments. However, even in a case of cold laminating, as long as the temperature of the paper inputted to the laminator 15 is about 55° C., the lamination film 154 will not be deformed and poor adhesion will not occur.

For these reasons, the second path 112 may have a length that allows the paper to be naturally cooled until the temperature drops below the predetermined temperature during conveyance.

Meanwhile, the control part 100 may slow down a conveyance speed such that the paper conveyed through the second path 112 is at the predetermined temperature or lower. When the conveyance speed is slowed down, the control part 100 also delays an image formation timing in the image forming part 10.

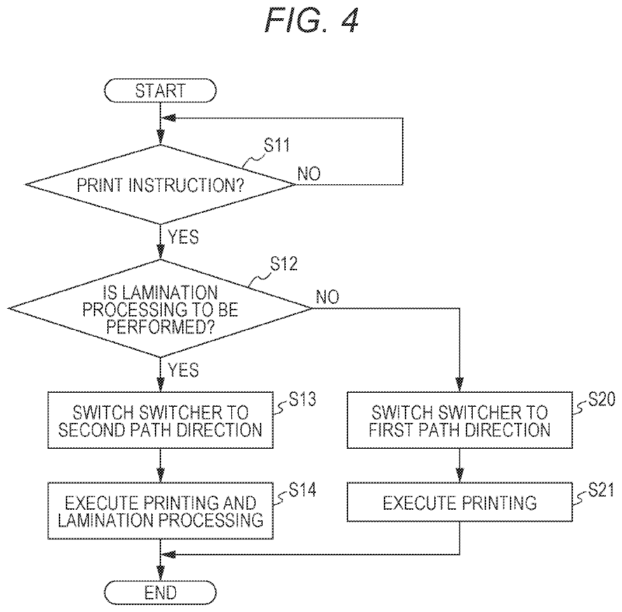

FIG. 4 is a flowchart showing a processing procedure of an image forming method. This processing procedure is executed by the control part 100.

The control part 100 first determines whether or not there is an input of a print instruction (S11). The print instruction is inputted from, for example, the operation display part 18. Further, the print instruction is inputted as a print job from an external device, for example. In inputting of the print instruction from the operation display part 18, when lamination processing is to be performed, an instruction to that effect is also inputted. Further, in inputting of the print job, an instruction to execute lamination processing is described as a job ticket.

When it is determined in the step of S11 that there is no input of the print instruction (S11: NO), the control part 100 waits for the input of the print instruction.

When it is determined that the print instruction has been inputted in the step of S11 (S11: YES), the control part 100 determines whether or not to perform lamination processing after printing (S12).

When it is determined in the step of S12 that the lamination processing is not to be performed (S12: NO), the control part 100 switches the switcher 40 to the direction in which the paper is conveyed to the first path 111 (S20).

After that, the control part 100 executes printing (S21) and ends the process. In this case, the printed paper is loaded on the first paper loading part 141.

Whereas, in the step of S12, when it is determined that the lamination processing is to be performed after printing (S12: YES), the control part 100 switches the switcher 40 to the direction in which the paper is conveyed to the second path 112 (S13).

After that, the control part 100 executes printing and lamination processing (S14). In this case, the printed paper is subjected to lamination processing and loaded on the second paper loading part 190.

According to the first embodiment described above, the following effects are obtained.

In the first embodiment, the second path 112 is provided in order to convey paper after printing on which lamination processing is to be performed. The second path 112 is a conveyance path different from the first path 111 that conveys paper on which lamination processing is not to be performed. The paper conveyed through the second path 112 is naturally cooled until the temperature drops below the predetermined temperature. Therefore, in the first embodiment, since cold lamination processing is performed, wax that has cooled and solidified after fixing does not melt again to be precipitated. Therefore, in the first embodiment, even if printed matter uses toner, it is possible to obtain printed matter that has been subjected to lamination processing in a good state without image defects or poor adhesion of the lamination film.

Further, in the first embodiment, since the paper temperature can be lowered, poor adhesion of the film can be suppressed even if the lamination film 154 for cold laminating is used.

Further, since the second path 112 is arranged so as to pass above the first paper loading part 141, a length of the entire image forming apparatus 1 (a total length in a direction of the conveyance path) can be shortened as much as possible. For example, the first paper loading part 141 can also be installed further downstream of the laminator 15, and the conveyance path can be switched immediately before the laminator 15. However, in such a case, by providing a path for cooling the paper corresponding to the second path 112 before the laminator 15, a length of the entire image forming apparatus 1 is to be accordingly longer than that of the first embodiment.

Note that, the first embodiment of the present invention does not exclude the form in which the first paper loading part 141 is installed further downstream of the laminator 15 and the second path 112 is installed before the laminator 15. Even in such a form of the configuration, a size of the entire image apparatus is different, but the present invention can be carried out. Hereinafter, the same applies to other embodiments.

### Second Embodiment

A second embodiment has a cooling part that forcibly cools paper conveyed inside a paper stocker 14.

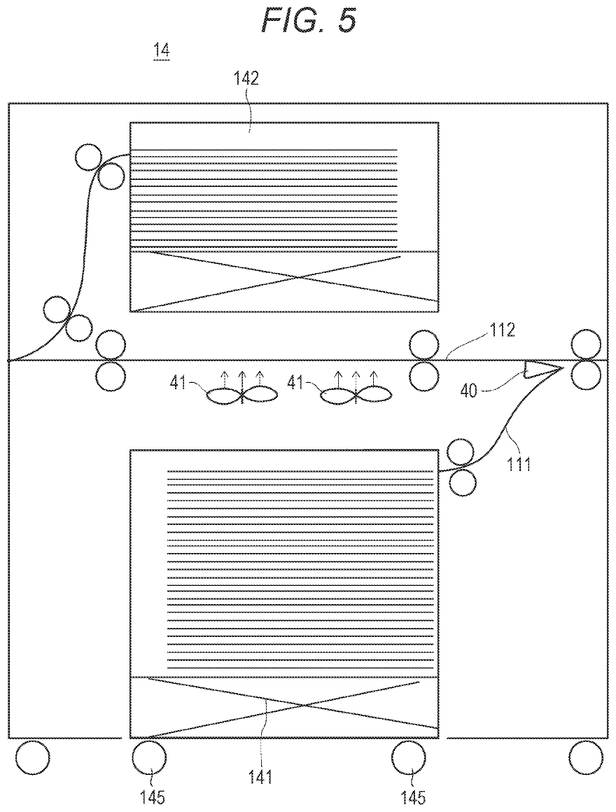

FIG. 5 is an enlarged side view of a paper stocker portion in the second embodiment.

Also in the second embodiment, similarly to the first embodiment, a first path 111, a second path 112, and a switcher 40 that switches a path are provided. Then, in the second embodiment, a fan 41 that blows an airflow onto paper conveyed through the second path 112 is provided. The fan 41 is a cooling part that forcibly cools paper, and is controlled by a control part 100.

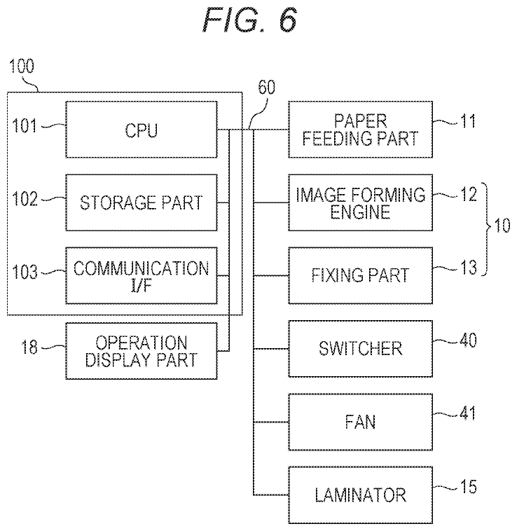

FIG. 6 is a block diagram showing a control system of an image forming apparatus 1 according to the second embodiment. In the second embodiment, the control part 100 is connected to a paper feeding part 11, an image forming engine 12, a fixing part 13, the switcher 40, the fan 41, and a laminator 15 by a signal line 60.

Since the configurations other than the fan 41 are the similar to those in the first embodiment, and the overall configuration of the image forming apparatus 1 is also similar to that in the first embodiment, the description thereof will be omitted.

A processing procedure of an image forming method in the second embodiment is basically similar to the flowchart described with reference to FIG. 4 in the first embodiment. However, in the second embodiment, the following steps are different.

When lamination processing is to be performed, in the step of S13, the control part 100 directs the switcher 40 to the second path 112 and operates the fan 41. Whereas, when the lamination processing is not to be performed, in the step of S20, the control part 100 directs the switcher 40 to the first path 111 and stops the fan 41. The control of the fan 41 may be stopped after the job of the lamination processing is ended. Since other processing procedures are similar to those in the first embodiment, the description thereof will be omitted.

According to the second embodiment described above, the following effects are obtained.

In the second embodiment, the fan 41 that blows an airflow onto paper conveyed through the second path 112 is provided. This causes the paper conveyed through the second path 112 to be forcibly cooled by the airflow, until the temperature drops below the predetermined temperature. Therefore, even if the second path 112 of the second embodiment is shorter than that of the first embodiment, reprecipitation of wax can be suppressed similarly to the first embodiment. Therefore, also in the second embodiment, similarly to the first embodiment, even if printed matter uses toner, it is possible to obtain printed matter that has been subjected to lamination processing in a good state without image defects or poor adhesion of the lamination film.

Further, in the second embodiment, a conveyance speed can also be increased by forcibly cooling the paper. Therefore, in the second embodiment, productivity of the job can be improved.

In addition, effects similar to those of the first embodiment are obtained.

In FIG. 5, the configuration is such that the airflow hits a paper surface vertically from below the second path 112, but a position of the fan 41 and a direction of the airflow are not limited to this. For example, the airflow may be blown onto the paper surface from above the second path 112. Further, the direction of the airflow is not limited to the configuration of blowing vertically on the paper surface, and the airflow may be blown diagonally. Further, the fan 41 may be installed on a side of the second path 112 such that the airflow flows along the paper surface from an end of the paper.

Further, FIG. 5 has shown a configuration in which a plurality of fans 41 are arranged, but the number of fans 41 may be one, or may be even more.

### Third Embodiment

A third embodiment has a cooling part that forcibly cools paper, similarly to the second embodiment.

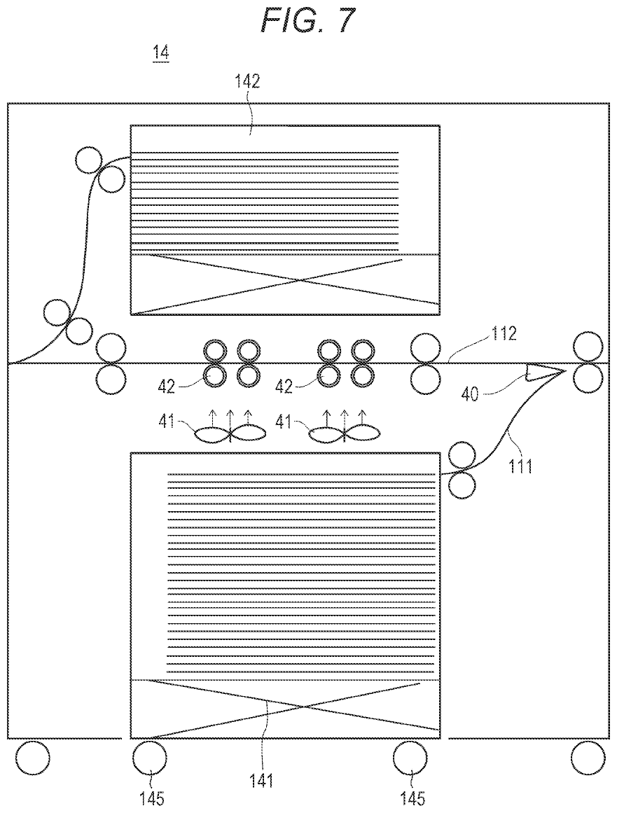

FIG. 7 is an enlarged side view of a paper stocker portion in the third embodiment.

Also in the third embodiment, similarly to the first embodiment, a first path 111, a second path 112, and a switcher 40 that switches a path are provided. Then, in the third embodiment, a heat transfer material 42 that comes into contact with paper conveyed through the second path 112 is provided as the cooling part.

The heat transfer material 42 is, for example, a metal roller of aluminum, copper, stainless steel, or the like. The metal roller, which is the heat transfer material 42, is driven to rotate with conveyance of paper.

Further, in the third embodiment, a fan 41 is provided to further cool the heat transfer material 42. It suffices that an airflow from the fan 41 can cool the heat transfer material 42, and the airflow does not need to reach the paper conveyed through the second path 112.

In the control in the third embodiment, the fan 41 is operated in a case of lamination processing. Whereas, the heat transfer material 42 is not specially controlled. Therefore, the control in the third embodiment is similar to that in the second embodiment.

Further, since the configurations other than the heat transfer material 42 are similar to those in the first or second embodiment, the description thereof will be omitted.

According to the third embodiment described above, the following effects are obtained.

In the third embodiment, the heat transfer material 42 is brought into contact with paper conveyed through the second path 112 to cool the paper. This enables the heat transfer material 42 in contact with the paper to take heat away from the paper conveyed through the second path 112, so that the cooling efficiency is high. In particular, in the third embodiment, the heat transfer material 42 is cooled by the fan 41. Therefore, in the third embodiment, even in printing on a large amount of paper and continuously performing lamination processing, heat is not accumulated in the heat transfer material 42, so that the cooling efficiency does not decrease.

Therefore, even if the second path 112 of the third embodiment is even shorter than that of the second embodiment, reprecipitation of wax can be suppressed similarly to the first embodiment. Therefore, also in the third embodiment, similarly to the first and second embodiments, even if printed matter uses toner, it is possible to obtain printed matter that has been subjected to lamination processing in a good state without image defects or poor adhesion of the lamination film.

Further, in the third embodiment, a conveyance speed can be further increased as compared with the second embodiment. Therefore, in the third embodiment, productivity of the job can be further improved.

In addition, effects similar to those of the first embodiment are obtained.

In FIG. 7, the configuration is such that the airflow hits the heat transfer material 42 vertically from below the heat transfer material 42, but a position of the fan 41 and a direction of the airflow are not limited to this. For example, the direction of the airflow is not limited a configuration of blowing the heat transfer material 42 vertically, and the airflow may be blown diagonally. Further, the fan 41 may be installed on a side of a rotation shaft of the metal roller, which is the heat transfer material 42, so that the airflow flows along the metal roller from an end of the metal roller.

Further, the fan 41 that cools the heat transfer material 42 may be omitted. When the fan 41 is omitted, the processing procedure is the same as that in the first embodiment.

Further, without limiting to a roller form, the heat transfer material 42 may be, for example, a metal plate or a metal thread that the paper is slidably contacted with.

Further, the heat transfer material 42 in the roller form may be driven by a power source and rotate synchronously with other conveyance rollers. In a case of a roller driven by a power source, in the processing procedure, the roller is driven in the step of S13, and the driving is stopped in the step of S20. Further, the roller may be stopped at the same time as an end of lamination processing.

Further, FIG. 7 has shown a configuration in which a plurality of heat transfer materials 42 and fans 41 are arranged, but each number of heat transfer materials 42 and fans 41 may be one, or may be even more.

### Fourth Embodiment

A fourth embodiment has a loading paper cooling part that cools a first paper loading part 141.

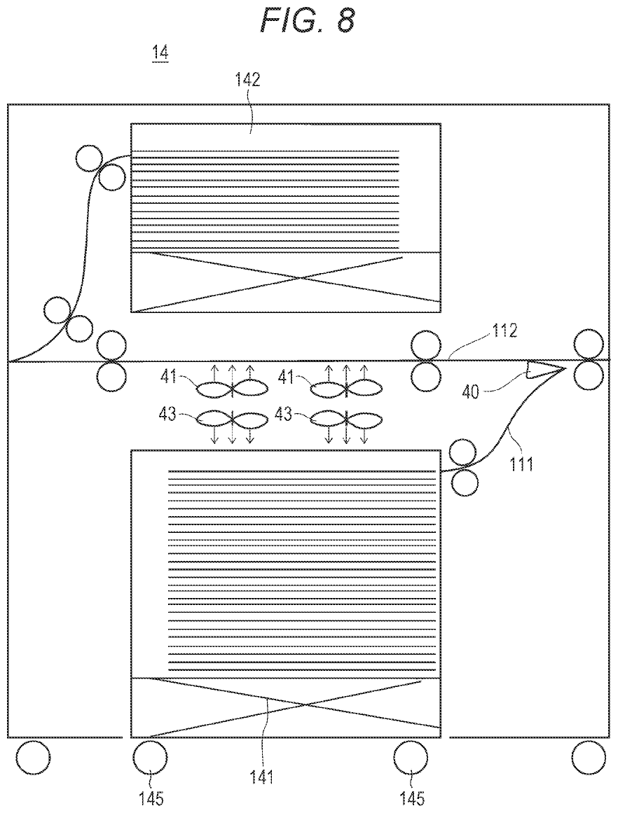

FIG. 8 is an enlarged side view of a paper stocker portion in the fourth embodiment.

Also in the fourth embodiment, similarly to the first embodiment, a first path 111, a second path 112, and a switcher 40 that switches a path are provided. Then, in the fourth embodiment, a loading paper cooling fan 43 that blows an airflow in a direction of the first paper loading part 141 is provided.

In one or more embodiments, the loading paper cooling fan 43 may be constantly operated during a printing operation. This is because, by constantly operating the loading paper cooling fan 43, lamination processing can be executed immediately after printing for which the lamination processing is not executed (details will be described later).

The loading paper cooling fan 43 may be operated exclusively when the lamination processing is performed. In this case, the control part 100 also operates the loading paper cooling fan 43 at the same time as an operation start of the fan 41.

Further, since the configurations other than the loading paper cooling fan 43 are similar to those in the first embodiment, the description thereof will be omitted.

According to the fourth embodiment described above, the following effects are obtained.

As described above, the second path 112 is arranged above the first paper loading part 141. Then, paper after printing is loaded as it is on the first paper loading part 141. Therefore, in the first paper loading part 141, when printing is continuously performed, the paper heated during printing is loaded one after another without being cooled. In such a state, the heat of the paper loaded on the first paper loading part 141 warms the surroundings. Then, when the fan 41 blows an airflow in a direction of the second path 112, the warm airflow is blown to paper conveyed through the second path 112, and the cooling efficiency of the paper is lowered.

In the fourth embodiment, since the loading paper cooling fan 43 is provided, the paper loaded on the first paper loading part 141 can be cooled. Therefore, in the fourth embodiment, even if the fan 41 blows the airflow in the direction of the second path 112, the warm airflow is not blown on the paper conveyed through the second path 112. Accordingly, in the fourth embodiment, the cooling efficiency of the paper conveyed through the second path 112 does not decrease.

In particular, in the fourth embodiment, by constantly operating the loading paper cooling fan 43 during the printing operation, the lamination processing can be immediately executed since the heat generated by the loaded paper does not affect the second path 112 even immediately after printing for which lamination processing is not performed.

Although FIG. 8 shows a configuration in which a plurality of loading paper cooling fans 43 are arranged, the number of loading paper cooling fans 43 may be one, or may be even more.

Therefore, in the fourth embodiment, the lamination processing can be immediately performed even after a large amount of printing without lamination processing is continuously performed.

In addition, effect similar to those of the first and second embodiments are obtained.

Although the embodiments have been described above, the present invention is not limited to the above-described embodiments.

Further, the image forming medium may be other than paper. For example, such as a cloth or a resin film, the image forming medium is not particularly limited, as long as an image can be formed by the electrophotographic method and lamination processing can be performed.

Although embodiments of the present invention have been described and illustrated in detail, the disclosed embodiments are made for purposes of illustration and example only and not limitation. The scope of the present invention should be interpreted by terms of the appended claims.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image forming apparatus comprising:
an image former that forms an image with toner containing wax on an image forming medium conveyed in a conveyance direction;
a first paper loading part that loads the image forming medium and is disposed downstream of the image former in the conveyance direction;
a laminator that laminates a film on the image forming medium;
a second paper loading part that loads the image forming medium and is disposed downstream of the laminator in the conveyance direction;
a first path that extends from the image former to the first paper loading part;
a second path that is different from the first path and that extends from the image former to the laminator;
a switcher that switches a conveyance path of the image forming medium outputted from the image former to either the first path or the second path; and
a hardware processor that causes the switcher to switch the conveyance path to the second path when the laminator laminates the film on the image forming medium.

2. The image forming apparatus according to claim 1, further comprising:
a cooling part that cools the second path.

3. The image forming apparatus according to claim 2, wherein the cooling part comprises a fan that blows an air onto the image forming medium conveyed through the second path.

4. The image forming apparatus according to claim 2, wherein the cooling part comprises a heat transfer material that contacts the image forming medium conveyed through the second path.

5. The image forming apparatus according to claim 1, wherein the second path is arranged above the first paper loading part.

6. The image forming apparatus according to claim 5, further comprising:
a loading paper cooling fan that cools the first paper loading part.

7. The image forming apparatus according to claim 1, wherein a temperature of the image forming medium becomes equal to or lower than a predetermined temperature by a time when the image forming medium conveyed through the second path reaches the laminator.

8. The image forming apparatus according to claim 7, wherein the predetermined temperature is lower than a temperature at which the wax softens.

9. The image forming apparatus according to claim 1, wherein the laminator is a cold laminator.

10. An image forming method using an image forming apparatus that comprises a first path and a second path different from the first path, wherein an image forming medium on which an image is formed with toner containing wax is conveyed though the first path without lamination of a film or conveyed through the second path toward a laminator that laminates the film, the method comprising:
conveying the image forming medium through the second path toward the laminator; and
laminating, with the laminator, the film on the image forming medium.

11. The image forming method according to claim 10, further comprising:
cooling the image forming medium conveyed through the second path by blowing an air.

12. The image forming method according to claim 10, further comprising:
cooling the image forming medium conveyed through the second path by making a heat transfer material contact the image forming medium.
